(19) United States
(12) Patent Application Publication
(10) Pub. No.: US 2003/0061154 A1
(43) Pub. Date: Mar. 27, 2003

(54) Systems and methods to facilitate an acquisition of information associated with a requested financial account

(76) Inventor: Bobby J. Chacko, New York, NY (US)

Correspondence Address: BUCKLEY, MASCHOFF, TALWALKAR, & ALLISON, 5 ELM STREET, NEW CANAAN, CT, 06840, US

(21) Appl. No.: 09/961,763

(22) Filed: Sep. 24, 2001

(51) Int. Cl. G06F 17/60

(52) U.S. Cl. 705/39

(57) ABSTRACT

Systems and methods are provided to facilitate an acquisition of information associated with a requested financial account. According to one embodiment, application information is received from a wireless device located at a merchant's premises, the application information being associated with a requested financial account. For example, a customer's credit card application information may be received from a wireless PDA at a merchant's store. It is then arranged for the application information to be provided to a remote decision system associated with the requested financial account. For example, the customer's credit card application information may be transmitted to a system associated with a credit card company.

### FIELD

The present invention relates to financial accounts, such as credit card accounts. In particular, the present invention relates to systems and methods to facilitate an acquisition of information associated with a requested financial account.

### BACKGROUND

Information associated with a requested financial account, such as credit card application information, can be acquired from people in a number of different ways. For example, a credit card company can mail a printed credit card application form to a person, who may then complete the form and mail it back to the credit card company. The effectiveness of such an approach, however, is limited because there is no personal interaction between the credit card company and the person. Moreover, the person who receives the form may have no interest in applying for a credit card account (e.g., because he or she is not thinking about making a purchase when the form is received).

It is also known that a number of printed credit card applications can be displayed at a location (e.g., at a merchant's store). In this case, a person may take one of the forms and mail the completed form to the credit card company. One advantage of such an “in-store” approach is that a person who sees the credit card application forms may well be thinking about making a purchase (e.g., from the merchant). Even this approach, however, has a number of disadvantages. For example, a person may not notice the display of credit card applications. In addition, there is still no personal interaction between the credit card company and the person. Even if the credit card company arranged for an employee to be present at the display (e.g., to attract people to a “table event”), the person will still need to wait a significant period of time before he or she can use the credit card account (e.g., it may take a week or more before the person actually receives a credit card).

To solve some of these problems, a merchant can let a person apply for a credit card via a Point Of Sale (POS) terminal, such as a cash register. For example, a person may verbally communicate his or her name, address, and Social Security number to a salesperson at a POS terminal. The salesperson can enter the information into the POS terminal (or related device), which in turn communicates with a decision system (e.g., a server operated by a credit card company). With this approach, a credit card application may be quickly approved, letting the person use his or her new credit card account in substantially real time (e.g., almost immediately).

Acquiring credit card application information via a POS terminal also poses a number of problems. For example, a salesperson might incorrectly enter information into the POS terminal (e.g., an incorrect Social Security number), causing a card application to be mistakenly declined by the decision system. Moreover, entering such information and waiting for approval from the decision system (e.g., for sixty seconds) can be time-consuming process that prevents the POS terminal from being used to help other customers (e.g., who are purchasing items from the merchant).

Another disadvantage is that the system requires special hardware, software, and/or communication lines (e.g., the system may require a dedicated telephone line between the POS terminal and the credit card company decision system). When the credit card company is not directly affiliated with the merchant, it may not be practical to install such a system for a limited period of time. Consider, for example, a VISA® credit card company that wants to acquire credit card application information from HOME DEPOT® customers for a two week period. In this case, it is unlikely that HOME DEPOT® will want to install special hardware, software, and/or communication lines to support the program for such a limited period of time.

A merchant or credit card company may instead acquire credit card application information using a device separate from a POS terminal. For example, a stand-alone kiosk may be installed to collect credit card application information. This approach also has a number of disadvantages. For example, there may be no practical way to verify the identity of a person who provides information at the kiosk, thus increasing the risk that people will attempt to fraudulently obtain credit card accounts.

Moreover, a wired communication line between the kiosk and the credit card company decision system may still be required (e.g., a telephone line or a T1 Internet connection), and the merchant may be unable, or unwilling, to provide such a communication line—especially for a limited period of time. Note that other problems may occur if the kiosk instead communicates with the decision system via a wireless network (e.g., a public cellular telephone network). For example, many decision systems prevent remote devices from re-submitting duplicate or associated information. That is, if an incomplete set of credit card application information is received (e.g., a name, an address, and part of a Social Security number), the application is declined and any further information associated with the application is blocked to reduce fraudulent applications. Thus, a stand-alone kiosk that relies on a potentially unreliable communication link (e.g., a public cellular telephone network) may cause a significant number of applications to be declined.

### SUMMARY

To alleviate problems inherent in the prior art, the present invention introduces systems and methods to facilitate an acquisition of information associated with a requested financial account.

According to one embodiment, application information associated with a requested financial account is received from a wireless device located at a merchant's premises. It is then arranged for the application information to be provided to a remote decision system associated with the requested financial account.

In another embodiment, application information is received from a mobile device via a wireless network at a location, the application information being associated with a requested credit card account. A forwarding server at the location verifies that the application information is complete, and the application information is transmitted to a remote decision system via a wired network. The decision system is associated with the requested credit card account, but is not directly associated with the location. An application response is received from the decision system via the wired network, and the application response is then transmitted to the mobile device via the wireless network.

In still another embodiment, application information is received from a customer. The application information is transmitted to a forwarding server via a wireless network, the forwarding server being in communication with a decision system. An application response generated by the decision system is then received from the forwarding server via the wireless network.

One embodiment of the present invention comprises: means for receiving application information from a wireless device located at a merchant's premises, the application information being associated with the requested financial account; and means for arranging for the application information to be provided to a remote decision system associated with the requested financial account.

Another embodiment of the present invention comprises: means for receiving application information from a mobile device via a wireless network at a location, the application information being associated with the requested credit card account; means for verifying that the application information is complete at a forwarding server located at the location; means for transmitting the application information to a remote decision system via a wired network, wherein the decision system (i) is associated with the requested credit card account and (ii) is not directly associated with the location; means for receiving an application response from the decision system via the wired network; and means for transmitting the application response to the mobile device via the wireless network.

Still another embodiment of the present invention comprises: means for receiving application information from a customer; means for transmitting the application information to a forwarding server via a wireless network, the forwarding server being in communication with a decision system; and means for receiving an application response from the forwarding server via the wireless network, the application response being generated by the decision system.

With these and other advantages and features of the invention that will become hereinafter apparent, the invention may be more clearly understood by reference to the following detailed description of the invention, the appended claims, and the drawings attached herein.

### BRIEF DESCRIPTION OF THE DRAWINGS

FIG. 1 is a block diagram overview of an application system according to some embodiments of the present invention.

FIG. 2 is an information flow diagram according to some embodiments of the present invention.

FIG. 3 is a block diagram of a forwarding server according to an embodiment of the present invention.

FIG. 4 is a tabular representation of a portion of an application information database according to an embodiment of the present invention.

FIG. 5 is a tabular representation of a portion of an application response database according to an embodiment of the present invention.

FIG. 6 is a flow chart of a forwarding server method according to some embodiments of the present invention.

FIG. 7 is a block diagram of a wireless device according to an embodiment of the present invention.

FIG. 8 is a flow chart of a wireless device method according to some embodiments of the present invention.

FIG. 9 illustrates a wireless device including an application information display according to an embodiment of the present invention.

FIG. 10 illustrates a wireless device including an electronic signature display according to an embodiment of the present invention.

FIG. 11 is a flow chart of an application program method according to some embodiments of the present invention.

FIG. 12 is a flow chart of method for approaching a customer according to some embodiments of the present invention.

FIGS. 13 through 15 are flow charts of methods for collecting customer information according to some embodiments of the present invention.

FIG. 16 is a flow chart of method for conveying an application response to a customer according to some embodiments of the present invention.

### DETAILED DESCRIPTION

Embodiments of the present invention are directed to systems and methods to facilitate an acquisition of information associated with a requested “financial account.” As used herein, the phrase “financial account” refers to any type of financial account that may be applied for by a customer. Examples of financial accounts include credit card accounts, debit card accounts, bank accounts, and digital payment accounts.

Application System Overview

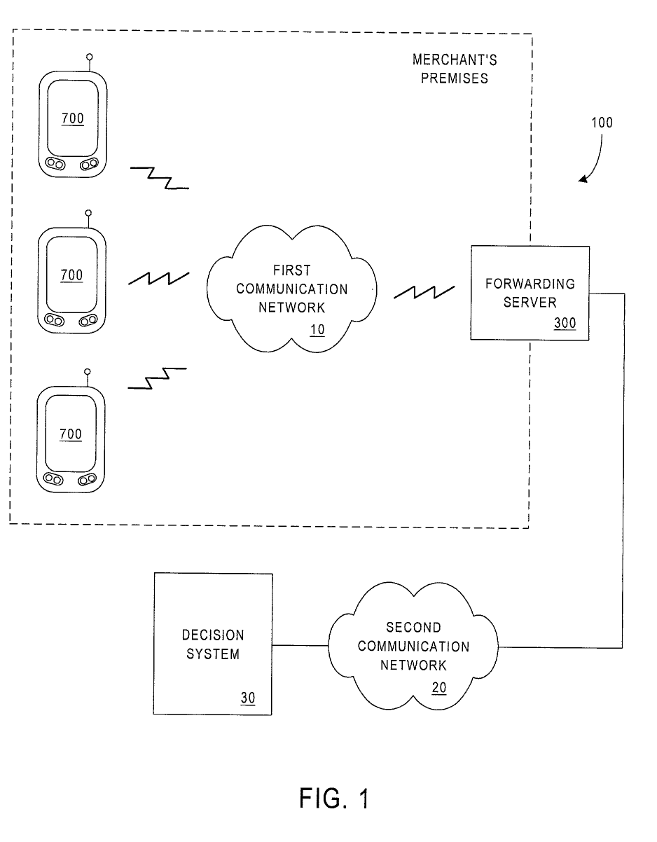

Turning now in detail to the drawings, FIG. 1 is a block diagram of an application system 100 according to some embodiments of the present invention. The application system 100 includes a forwarding server 300 in communication with a number of wireless devices 700 located at a merchant's premises via a first communication network 10. The first communication network 10 may comprise, for example, a wireless Local Area Network (LAN) (e.g., in accordance with the Institute of Electrical and Electronics Engineers 802.11 standard), an Infrared Radiation (IR) network, and/or a Bluetooth network. According to one embodiment, the first communication network 10 is associated with the wireless LAN ACCESS POINT system available from SYMBOL TECHNOLOGIES, INC.®

The forwarding server 300 also communicates with a decision system 30 via a second communication network 20. The decision system 30 may, for example, determine whether or not an application for a financial account will be accepted (e.g., via a server associated with a credit card company). The second communication network 20 may comprise, for example, a Public Switched Telephone Network (PSTN), a proprietary network, and/or an Internet Protocol (IP) such as the Internet, an intranet, or and extranet (e.g., via a T1 line).

Note that the forwarding server 300 may be a single device or multiple devices. For example, the forwarding server 300 may include a laptop computer acting as a local server at the merchant's premises. This local server may use an Internet Information Server (IIS) and Component Object Model Plus (COM+) components to communicate with wireless devices 700 via the first communication network 10 (e.g., via a 802.11 LAN) and with a remote server (e.g., via a wide area cellular digital packet data network). The local server may also use a task dispatcher and synchronization process to exchange encrypted information with a wireless device database 700 (e.g., to exchange application or response information via 128-bit encryption). The remote server may receive Secure Hypertext Transfer Protocol (HTTPS) information from the local server (e.g., via a T1 line) and communicate with the decision system 30 by exchanging data via the second communication network 20. In this case, the forwarding server 300 would include both the local server and the remote server.

Although a single forwarding server 300 is shown in FIG. 1, any number of forwarding servers 300 may be included in the application system 100. Similarly, any number of wireless devices 700, or any of the other devices described herein, may be included in the application system 100 according to embodiments of the present invention.

The forwarding server 300 and the wireless devices 700 may be any devices capable of performing the various functions described herein. Some specific examples of wireless devices 700 include a portable and/or mobile computing device, a Personal Digital Assistant (PDA), and/or a laptop computer. According to one embodiment, the wireless devices 700 comprise an SPT 1700 mobile computer (available from SYMBOL TECHNOLOGIES, INC.®) executing a PALM® operating system, a credit application, and an ULTRALITE® database.

Note that the devices shown in FIG. 1 need not be in constant communication. For example, the forwarding server 300 may communicate with a wireless device 700 on an as-needed or periodic basis.

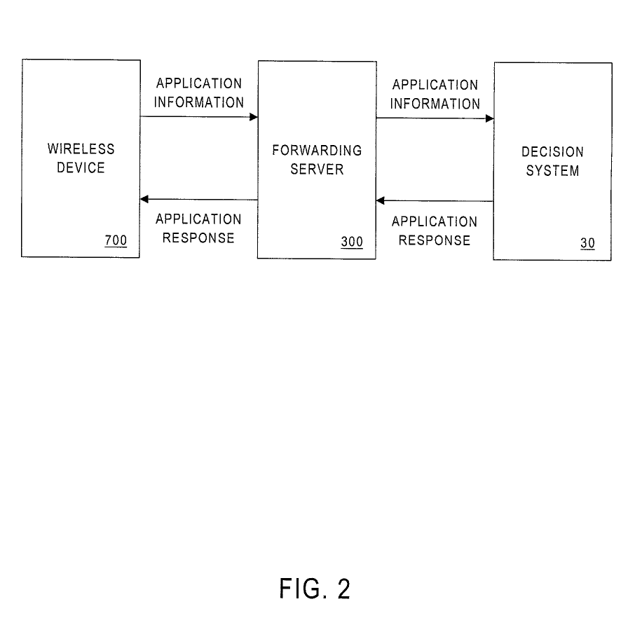

FIG. 2 is an information flow diagram according to some embodiments of the present invention. A wireless device 700 transmits application information to the forwarding server 300. For example, an operator of the wireless device may enter a customer's name and address into a PDA, which then transmits the application information to the forwarding server 300 via a wireless communication network. The forwarding server 300 then transmits application information to the decision system 30. For example, the forwarding server 300 may wait until a complete set of application information has been received from the wireless devices 700, re-format the application information, and then transmit the application information to the decision system 30 via another communication network (e.g., a wired communication network). In this way, the likelihood an incomplete set of application information being received at the decision system 30 (e.g., due to a communication failure) can be significantly reduced.

The decision system 30 returns an application response to the forwarding server 300 (e.g., indicating that a customer's application for a credit card account has been accepted). The forwarding server 300 then transmits the application response to the wireless device 700 via the wireless communication network.

Forwarding Server

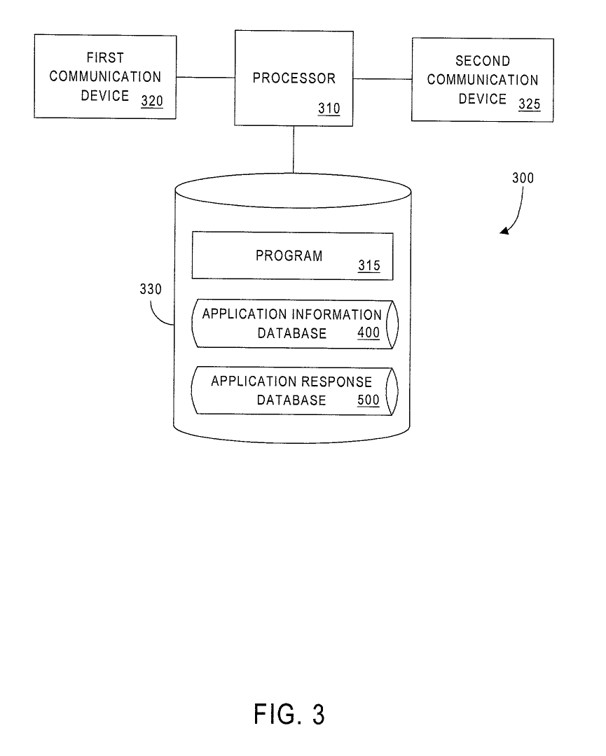

FIG. 3 illustrates a forwarding server 300 that is descriptive of the device shown, for example, in FIG. 1 according to some embodiments of the present invention. The forwarding server 300 comprises a processor 310, such as one or more INTEL® Pentium® processors, coupled to a first communication device 320 configured to communicate via a wireless communication network (not shown in FIG. 3). The communication device 320 may be used to communicate, for example, with one or more wireless devices 700. The processor 310 is also coupled to a second communication device 325 configured to communicate via a wired communication network (not shown in FIG. 3). The communication device 325 may be used to communicate, for example, with a decision system 30. According to another embodiment, a single communication device is configured to communicate with both the wireless devices 700 and the decision system 30.

The processor 310 is also in communication with a storage device 330. The storage device 330 may comprise any appropriate information storage device, including combinations of magnetic storage devices (e.g., magnetic tape and hard disk drives), optical storage devices, and/or semiconductor memory devices such as Random Access Memory (RAM) devices and Read Only Memory (ROM) devices.

The storage device 330 stores a program 315 for controlling the processor 310. The processor 310 performs instructions of the program 315, and thereby operates in accordance with the present invention. For example, the processor 310 may receive application information from a wireless device 700 located at a merchant's premises, the application information being associated with a requested financial account. The processor 310 may then arrange for the application information to be provided to a remote decision system 30 associated with the requested financial account.

According to another embodiment, the processor 310 receives application information from a mobile device at a location (e.g., an airport or shopping mall) via the first communication device 320, the application information being associated with a requested credit card account. After verifying that the application information is complete, the processor 310 transmits the application information to a remote decision system 30 via the second communication device 325. In this case, the decision system 30 is associated with the requested credit card account, but is not directly associated with the location (e.g., the airport or the shopping mall). An application response is received from the decision system 30 via the second communication device 325, and the processor 310 transmits the application response to the mobile device via the first communication device 320.

As used herein, information may be “received” by or “transmitted” to, for example: (i) the forwarding server 300 from a wireless device 700 and/or a decision system 30; or (ii) a software application or module within the forwarding server 300 from another software application, module, or any other source.

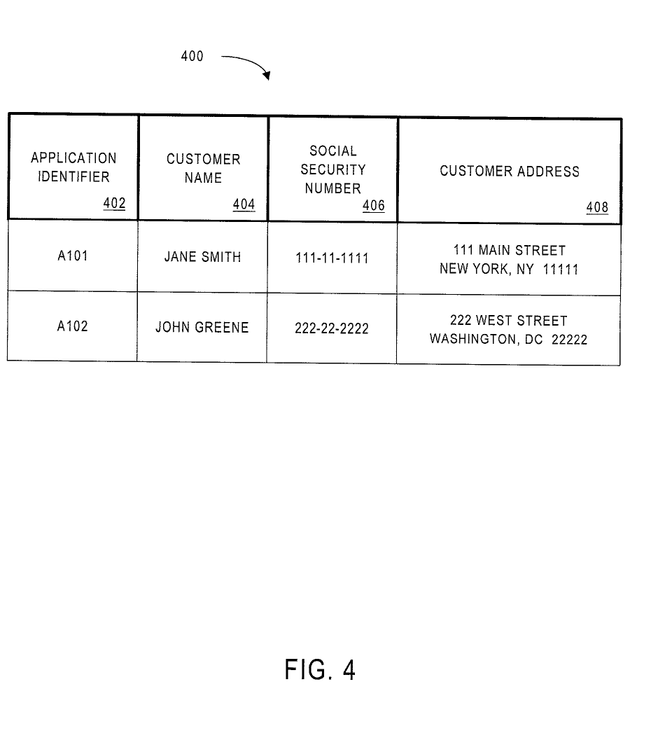

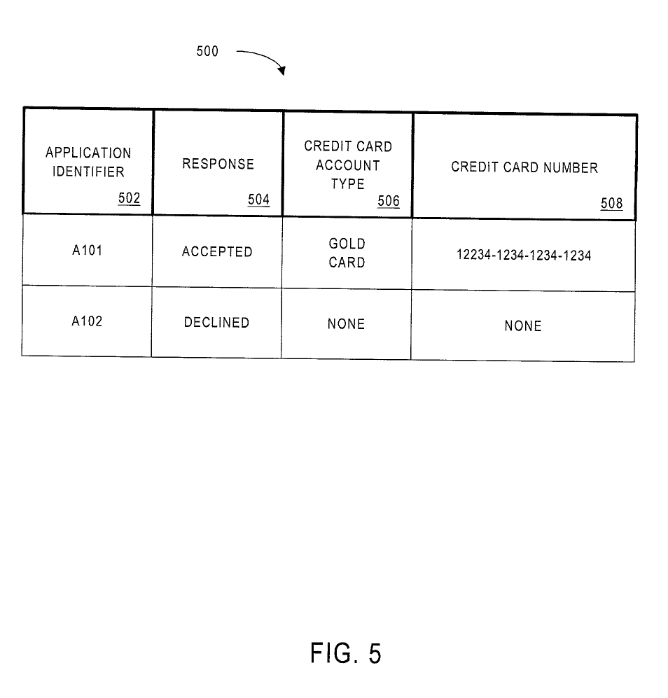

As shown in FIG. 3, the storage device 330 also stores an application information database 400 (described with respect to FIG. 4) and an application response database 500 (described with respect to FIG. 5). Examples of databases that may be used in connection with the application system 100 will now be described in detail. The illustrations and accompanying descriptions of the databases presented herein are exemplary, and any number of other database arrangements could be employed besides those suggested by the figures.

Application Information Database

Referring to FIG. 4, a table represents the application information database 400 that may be stored at the forwarding server 300 according to an embodiment of the present invention. The table includes entries identifying applications for financial accounts submitted via the application system 100. The table also defines fields 402, 404, 406, 408 for each of the entries. The fields specify: an application identifier 402, a customer name 404, a Social Security number 406, and a customer address 408. The information in the application information database 400 may be created and updated, for example, based on information received from a wireless device 700. Note that this information may only be stored for a brief period of time. For example, the information may only be stored until it is verified that the information is complete (e.g., the information may be erased after it is reformatted and/or transmitted to a decision system 30).

The application identifier 402 may be, for example, an alphanumeric code associated with an application for a financial account submitted via the application system 100 (e.g., when a customer requests a credit card account). Note that the application identifier 402 may be generated by a wireless device 700 or the forwarding server 300. According to another embodiment, the application identifier 402 is instead based on the customer's application information (e.g., the customer's Social Security number may act as an application identifier).

Information associated with the customer's application is stored in association with the application identifier 402. For example, the customer name 404, the Social Security number 406, and the customer address 408 are illustrated in FIG. 4. Of course, other information associated with the customer's application can also be stored in the application information database 400. For example, a date and time associated with an application, an address type (e.g., indicating if the customer owns or rents his or her home), an electronic representation of a customer's signature, a communication address (e.g., the customer's telephone number or electronic mail address), a date of birth, a financial account identifier (e.g., a credit card number of an existing credit card account associated with the customer), a requested amount of credit, one or more other authorized financial account users (e.g., a spouse or child), and/or a requested financial account type (e.g., indicating that a “silver” or a “gold” credit card account is being applied for) may be stored in the application information database 400.

Application Response Database

Referring to FIG. 5, a table represents the application response database 500 that may be stored at the forwarding server 300 according to an embodiment of the present invention. The table includes entries identifying responses to applications for financial accounts that have been returned via the application system 100. The table also defines fields 502, 504, 506, 508 for each of the entries. The fields specify: an application identifier 502, a response 504, a credit card account type 506, and a credit card number 508. The information in the application response database 500 may be created and updated, for example, based on information received from a decision system 30. Note that this information may only be stored for a brief period of time. For example, the information may only be stored until it is re-formatted and/or transmitted to a wireless device 700.

The application identifier 502 may be, for example, an alphanumeric code associated with a response to an application for a financial account that has been returned via the application system 100. According to one embodiment, the application identifier is based on, or associated with, the application identifier 402 stored in the application information database 400. The forwarding server 300 may use the application identifier 502, for example, to route an application response to an appropriate wireless device 700 (e.g., the device from which the application information was originally received).

Information associated with the application response is stored in association with the application identifier 402. For example, a response 504 (e.g., indicating that an application has been “accepted” or “declined”), a credit card account type (e.g., “gold” or “silver”), and a credit card number 508 are illustrated in FIG. 5. Of course, other information associated with the response can also be stored in the application response database 500. For example, terms and conditions associated with a financial account, an effective date of the financial account, an approved amount of credit, and/or a communication address (e.g., a customer-service telephone number) may be stored in the application response database 500.

According to one embodiment, discount information is also stored in the application response database. For example, a customer may be promised a ten percent discount if he or she: (i) applies for a credit card account, (i) is accepted for the credit card account, and (iii) uses the credit card account to make a purchase at a merchant's store. In this case, the discount information may be a code that the customer can provide at a POS terminal to qualify for the ten percent discount.

Forwarding Server Method

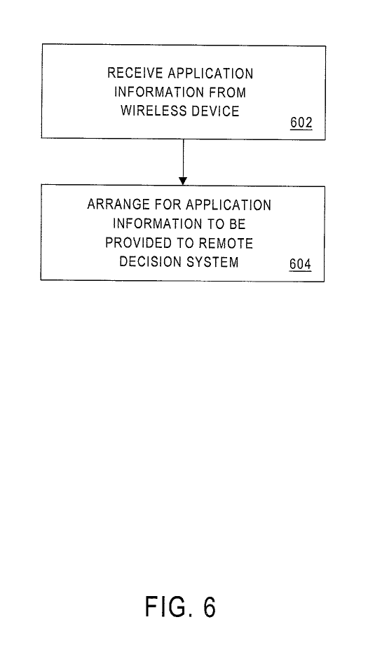

FIG. 6 is a flow chart of a method according to some embodiments of the present invention. The flow charts in FIG. 6 and the other figures described herein do not imply a fixed order to the steps, and embodiments of the present invention can be practiced in any order that is practicable. The method shown in FIG. 6 may be performed, for example, by the forwarding server 300.

At 602, application information is received from a wireless device 700 located at a merchant's premises, the application information being associated with a requested financial account. For example, a customer's name, Social Security number, and address may be received from the wireless device 700. Note that, as used herein, the word “customer” includes any person who may provide information associated with a request financial account (e.g., including people who have not, or are not, actually making a purchase). According to one embodiment, the requested financial account is associated with the merchant. For example, a customer at WAL-MART® may be requesting a WAL-MART® credit card account. Note that the forwarding server 300 may communicate with the wireless device 700 before all of the application information has been received from a customer (e.g., the wireless device 700 may begin to communicate with the forwarding server 300 while the customer or an operator is entering information into the wireless device 700).

At 604, it is arranged for the application information to be provided to a remote decision system 30 associated with the requested financial account. For example, the forwarding server 300 may re-format and transmit the application information to the decision system 30. According to some embodiments, the application information is received and/or transmitted via an encryption process (e.g., an encrypted customer name may be transmitted to protect the customer's privacy).

According to one embodiment, the forwarding server 300 verifies that the application information is complete before transmitting the application information to the decision system 30. If the application information is not complete (e.g., there was an error during transmission), the forwarding server 300 may ask a wireless device 700 to re-transmit the application information. In addition, the application information may be received via a wireless network and transmitted via a wired network (e.g., providing the flexibility of a wireless device 700 when the application information is collected and the reliability of a wired device when the application information is transmitted to the decision system 30).

The forwarding server 300 may also receive an application response from the decision system 30, such as an application response including an indication of acceptance (or denial), a financial account number, terms and conditions associated with the financial account, an effective date, an approved amount of credit, a financial account type, a communication address, and/or discount information. The forwarding server 300 may then reformat and transmit the application response to the customer via the appropriate wireless device 700.

Wireless Device

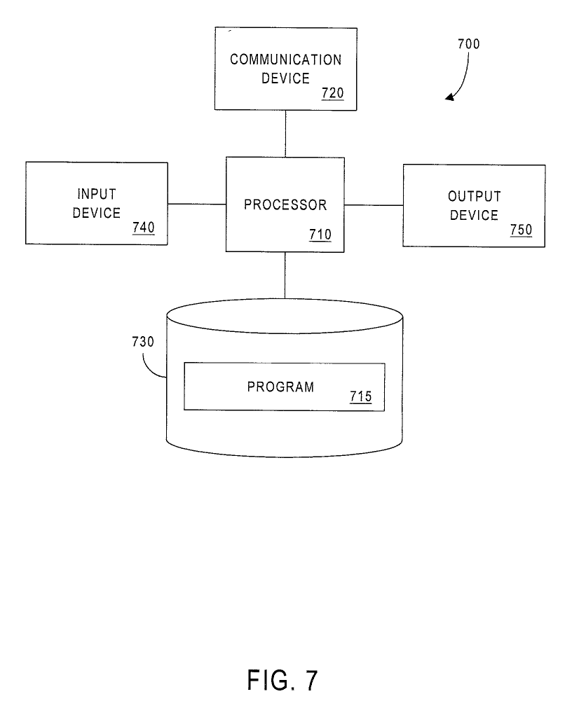

FIG. 7 illustrates a wireless device 700 that is descriptive of the device shown, for example, in FIG. 1 according to some embodiments of the present invention. The wireless device 700 comprises a processor 710, such as one or more INTEL® Pentium® processors, coupled to a communication device 720 configured to communicate via a wireless communication network (not shown in FIG. 7). The communication device 720 may be used to communicate, for example, with one or more forwarding servers 300.

The processor 710 is also in communication with an input device 740. The input device 740 may comprise, for example, a keyboard, a mouse or other pointing device, a microphone, a camera (e.g., to take a picture of the customer), and/or a touch screen. Such an input device 740 may be used, for example, to enter customer information (e.g., application information). Note that the input device 740 may receive information from, for example, a customer or an operator.

According to one embodiment, the input device 740 comprises a card reading device. For example, a customer may swipe an existing credit card via the card reading device. In this case, information read from the existing credit card can be used to generate application information for another financial account. According to another embodiment, the input device 740 comprises an electronic signature capturing device. For example, a customer may use a stylus to sign his or her name in connection with a credit card application.

The processor 710 is also in communication with an output device 750. The output device 750 may comprise, for example, a display (e.g., a display screen), a speaker, and/or a printer. The output device 750 may be used, for example, to provide information to a customer (e.g., a prompt to enter application information or an application response generated by a decision system 30).

According to one embodiment, the output device 750 comprises a printing device. For example, terms and conditions, a credit card number, and a discount code may be printed and provided to the customer (e.g., to let the customer immediately use his or her new financial account). According to another embodiment, the output device 750 comprises a card generating device. For example, a credit card may be generated for the customer at the merchant's premises (e.g., by embossing and/or magnetically encoding a credit card for the customer).

The processor 710 is also in communication with a storage device 730. The storage device 730 may comprise any appropriate information storage device, including combinations of magnetic storage devices, optical storage devices, and/or semiconductor memory devices such as RAM devices and ROM devices.

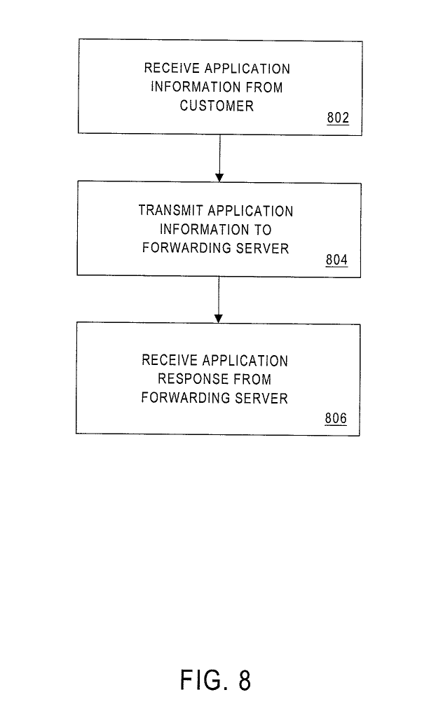

The storage device 730 stores a program 715 for controlling the processor 710. The processor 710 performs instructions of the program 715, and thereby operates in accordance with the present invention. For example, the processor 710 may perform the method illustrated in FIG. 8. At 802, application information is received from a customer (e.g., directly from the customer or via an operator who talks with the customer). At 804, the application information is transmitted to a forwarding server 300 via a wireless network, the forwarding server being in communication with a decision system 30. At 806, an application response is received from the forwarding server 300 via the wireless network, the application response being generated by the decision system 30.

As used herein, information may be “received” by or “transmitted” to, for example: (i) the wireless device 700 from the forwarding server 300; or (ii) a software application or module within the wireless device 700 from another software application, module, or any other source.

### EXAMPLES

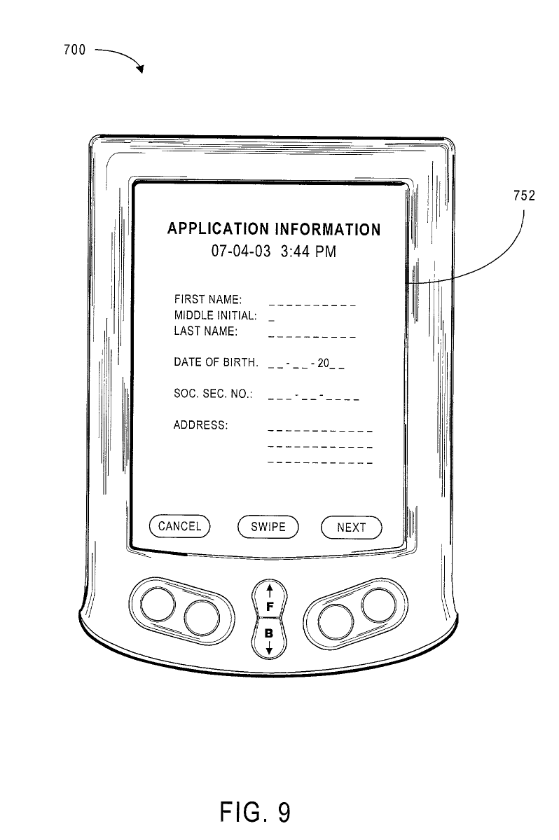

By way of example, FIG. 9 illustrates a wireless devoice 700 according to an embodiment of the present invention. In this case, an operator associated with a credit card account company approaches Jane as she is shopping at a merchant's store. The operator asks Jane if should be interested in applying for a credit card account that can be immediately used to receive a ten percent discount on any purchase made that day from the merchant.

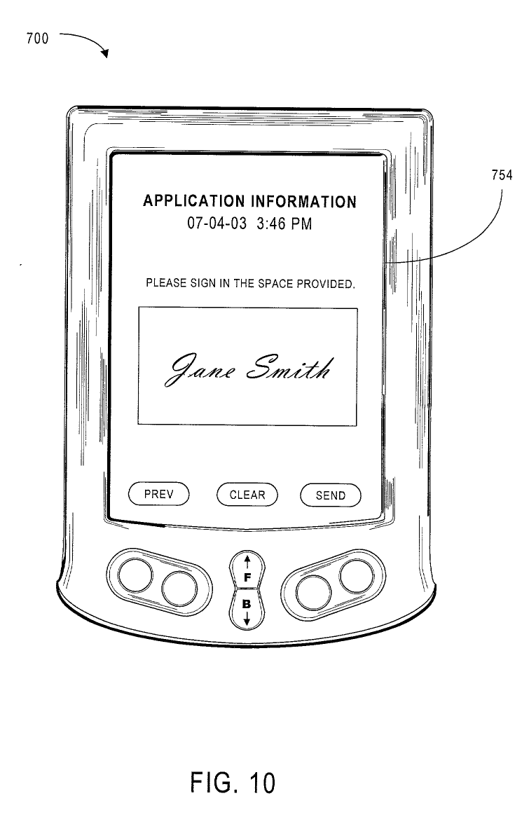

Jane agrees, and the operator uses the application information display 752 to enter Jane's name, date of birth, Social Security number, and address via the wireless device 700. The operator also verifies Jane's identify (e.g., by asking to see her drivers license). Jane reviews the application information and signs her name via the application information display 754 shown in FIG. 10.

The application information is sent from the wireless device to a forwarding server 300 (also located at the merchant's store). The forwarding server 300 verifies that the application information is complete (e.g., that no information was lost when it was transmitted), re-formats the information, and transmits the information to a remote decision system 30 associated with the credit card account.

An application response generated by the decision system 30 is then received at the wireless device 700 (e.g., via the forwarding system 300). Jane is given a credit card number and a discount code that she can immediate use to purchase items from the merchant at a discount.

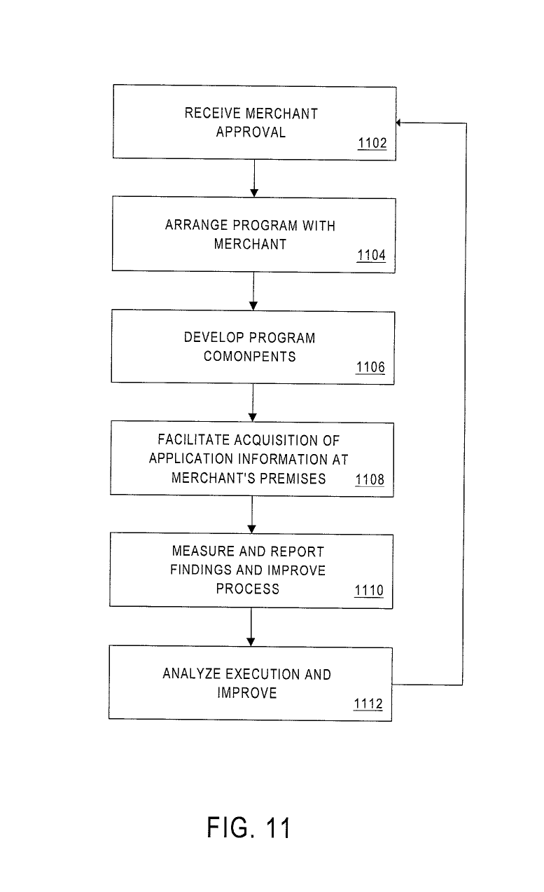

Several methods that may be used in connection with the application system 100 according to some embodiment of the present invention will now be described in detail with respect to FIGS. 11 through 16.

Application System Methods

FIG. 11 is a flow chart of an application program method according to some embodiments of the present invention. The method may be performed, for example, by a credit card company. At 1102, the credit card company receives approval from a merchant to acquire information at one or more of the merchant's stores. The credit card company then arranges the application program with the merchant at 1104. For example, a budget and time period associated with the program may be established. The particular stores in which the program will be conducted can also be arranged.

The credit card company also develops program components at 1106. For example, the manpower required to support the program may be established (e.g., an appropriate number of operators and wireless devices 700), and signage and incentives to support the program may be arranged.

At 1108, the acquisition of application information is facilitated at the merchant's premises (e.g., at one or more stores) in accordance with various embodiments of the present invention.

The success of the program is measured at 1110 (e.g., based on the number of customers who apply for a credit card account and/or are accepted by the decision system 30), and the findings are reported and used to improve the process. Finally, the execution of the program is analyzed and the process is further improved at 1112 before the program is repeated with another merchant.

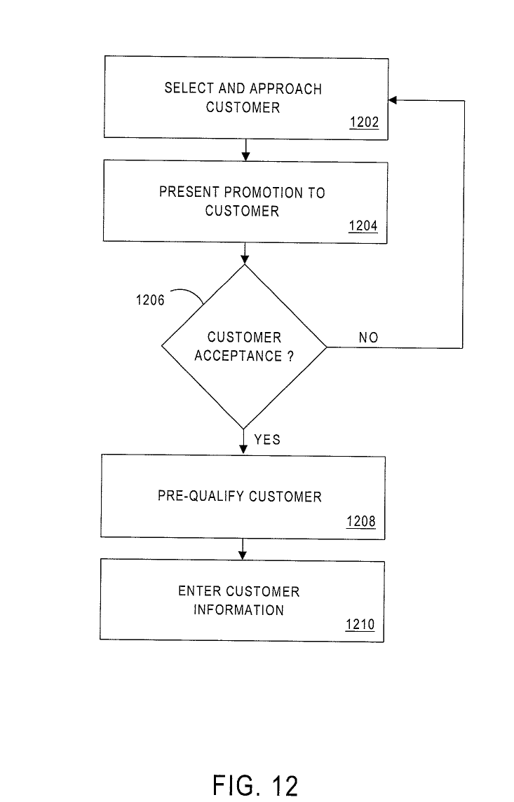

FIG. 12 is a flow chart of method for approaching a customer according to some embodiments of the present invention. At 1202, a customer is selected and approached by an operator associated with the program. For example, an operator may decide to approach a customer who is looking at a particular type of item at the merchant's store (e.g., an expensive stereo system).

The promotion is presented to the customer at 1204. For example, the operator may ask the customer if he or she is interested in applying for a credit card account that can be immediately used to receive a ten percent discount on any items that are purchased from the merchant on that day. If the customer does not accept the offer at 1206, another customer is approached at 1202.

If the customer accepts the offer at 1206, the operator pre-qualifies the customer at 1208. For example, the operator may ask the customer to present two form of identification (e.g., a drivers license and an existing credit card). Application information is then collected via a wireless device 700 at 1210 (e.g., by entering customer information). For example, the customer's name, address, and Social Security number may be collected.

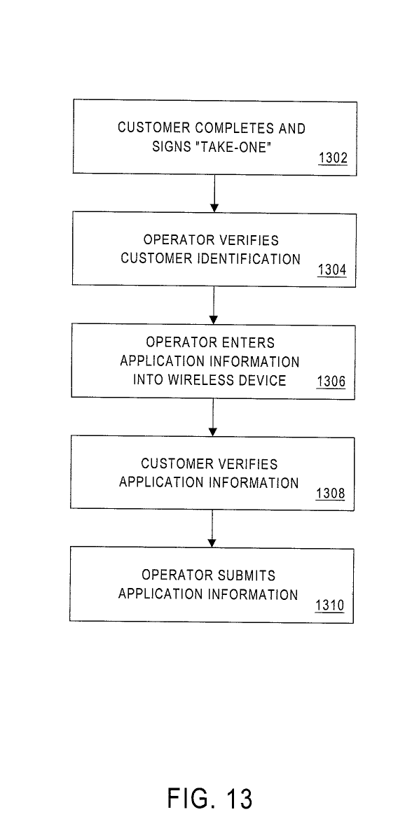

FIGS. 13 through 15 are flow charts of methods for collecting customer information according to some embodiments of the present invention. As illustrated in FIG. 13, a customer may complete and sign a printed “take-one” credit card application form at 1302 (e.g., by writing his or her name, address, and Social Security number on the form). The operator then verifies the customer's identification at 1304 (e.g., by asking the customer to produce a drivers license if he or she had not already done so).

The operator enters the information from the application form into a wireless device 700 at 1306, and the customer reviews and verifies the application information at 1308. The operator then submits the application at 1310 (e.g., by activating a “submit” button on the wireless device 700).

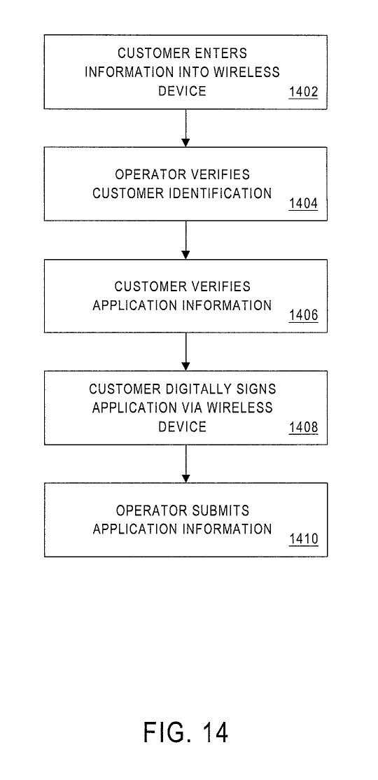

FIG. 14 illustrates a method in which the customer does not complete a printed credit card application form. In this case, the customer enters the information directly into the wireless device 700 at 1402. The operator may then verifies the customer's identification at 1404.

The customer verifies the application information at 1406, and digitally signs the application via the wireless device 700 at 1408 (e.g., using a stylus). The operator or the customer then submits the application at 1410 (e.g., by activating a “submit” button on the wireless device 700).

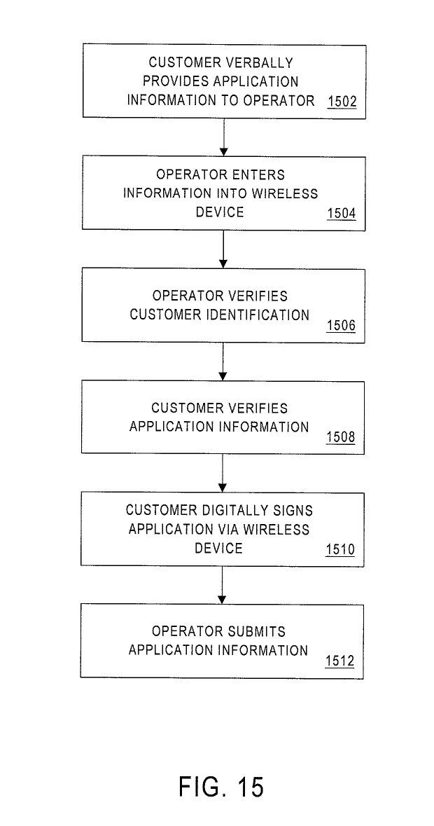

Refer now to FIG. 15, in which a customer verbally provides application to an operator at 1502 (e.g., by verbally answering a series of credit card application questions). In this case, the operator enters the information received from the customer into a wireless device 700 at 1504, and verifies the customer's identification at 1506. The customer reviews and verifies the application information at 1508, and digitally signs the application via the wireless device 700 at 1510. The operator then submits the application at 1512 (e.g., by activating a “submit” button on the wireless device 700).

The application information may be submitted, for example, from the wireless device 700 to forwarding server 300. The forwarding server 300 may store the application information in a local application information database 400 until it verifies that the application information is complete. The forwarding server 300 may then re-format the application information and transmits the information to a decision system 30 associated with the credit card company.

An application response may then be transmitted from the decision system 30 to the forwarding system 300, which in turn re-formats and transmits the application response to the wireless device 700.

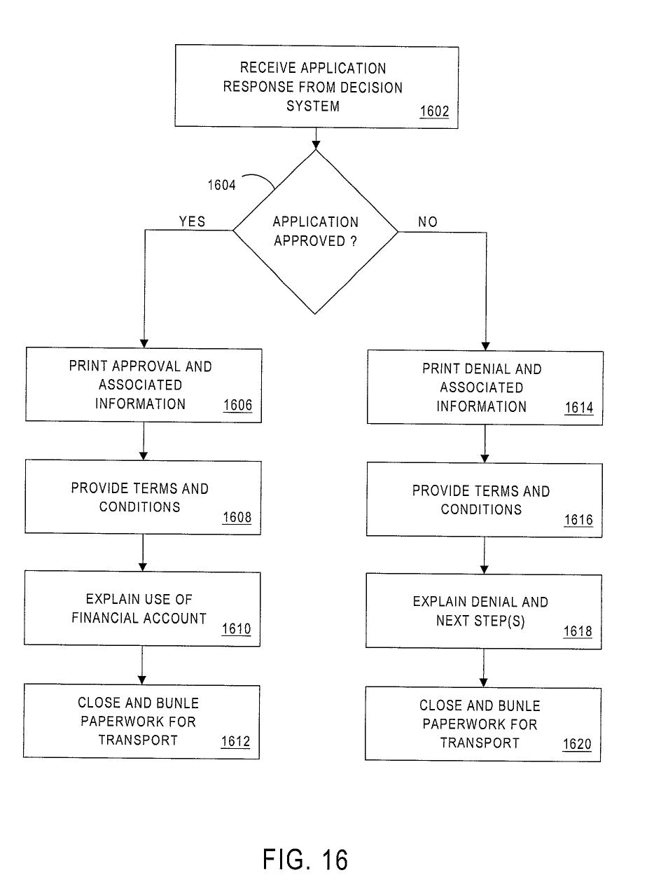

FIG. 16 is a flow chart of method for conveying the application response to a customer according to some embodiments of the present invention. The application response is initially received by the wireless device 700 from the forwarding system 300.

If the application is approved at 1604, the approval and associated information are printed by the wireless device 700 at 1606. For example, a credit card type (e.g., “silver” or “gold”), a credit card number, an approved credit limit, a customer-service number, and a discount code may be printed and provided to the customer. At 1608, legal terms and conditions associated with the credit card account are also provided to the customer (e.g., by either printing the terms and conditions or providing the customer with a pre-printed set of terms and conditions). The use of the financial account is explained at 1610 (e.g., by instructing the customer to provide the discount code at a POS terminal). Finally, the paperwork is closed and bundled for transport to the credit card company at 1612 (e.g., either manually or electronically via a communication network).

If the application is not approved at 1604, the denial and associated information are printed by the wireless device 700 at 1614. For example, a reason for denial may be provided to the customer (e.g., indicating that the application was denied because of the customer's credit rating). At 1616, legal terms and conditions associated with the credit card account may be provided to the customer (e.g., by either printing the terms and conditions or providing the customer with a pre-printed set of terms and conditions). The denial is explained to customer at 1618, along with suggestions as to the next steps the customer might want to take (e.g., such as a suggestion to contact a customer-service representative associated with the credit card company). Finally, the paperwork is closed and bundled for transport to the credit card company at 1202 (e.g., either manually or electronically via a communication network).

Additional Embodiments

The following illustrates various additional embodiments of the present invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

In many embodiments described herein, an application response is transmitted from the decision system 30 to a wireless device 700 via the forwarding system 300. According to another embodiment, however, the application response is instead transmitted directed from the decision system 30 to the wireless device 700. According to still other embodiments, the application response is transmitted from the decision system 30 to a customer's device (e.g., his or her own PDA) or to a POS terminal (e.g., where the customer can purchase an item using the financial account).

According to another embodiment, the wireless device 700 also acts as a mobile POS terminal. That is, a customer can apply for a credit card account and purchase an item via the wireless device 700. According to still another embodiment, the financial account is associated with the merchant. For example, the financial account may be credit card account that is co-branded with the merchant.

The present invention can be used to collect information in addition to information associated with a requested financial account, such as customer survey information . For example, a customer might provide his or her opinion about an item's price or quality while (or after) applying for a credit card account.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed is:

1. A method of facilitating an acquisition of information associated with a requested financial account, comprising:
receiving application information from a wireless device located at a merchant's premises, the application information being associated with the requested financial account; and
arranging for the application information to be provided to a remote decision system associated with the requested financial account.

2. The method of claim 1, wherein the application information is associated with a customer at the merchant's premises.

3. The method of claim 1, wherein the requested financial account is not directly associated with the merchant.

4. The method of claim 1, wherein the application information is received from at least one of: (i) a mobile device, (ii) a portable computing device, and (iii) a personal digital assistant.

5. The method of claim 1, wherein said arranging comprises:
transmitting the application information to the decision system.

6. The method of claim 5, wherein said receiving and transmitting are performed by a forwarding server located at the merchant's premises.

7. The method of claim 6, wherein the forwarding server comprises at least one of: (i) a portable computing device, and (ii) a laptop computer.

8. The method of claim 6, wherein the forwarding server verifies that the application information is complete before transmitting the application information to the decision system.

9. The method of claim 6, wherein said receiving is performed via at least one of: (i) a wireless network, (ii) a wireless local area network, (iii) an infrared network, (iv) a Bluetooth network, and (v) a cellular digital packet data network.

10. The method of claim 6, wherein said transmitting is performed via at least one of: (i) a telephone network, (ii) an Internet protocol network, (iii) the Internet, (iv) a wide area wireless network, and (v) a cellular network.

11. The method of claim 6, wherein said receiving is performed via a wireless network and said transmitting is performed via a wired network.

12. The method of claim 6, further comprising:
formatting the application information before the application information is transmitted to the decision system.

13. The method of claim 6, wherein at least one of said receiving and transmitting are performed via an encryption process.

14. The method of claim 1, wherein the application information comprises at least one of: (i) a customer name, (ii) an customer address, (iii) a Social Security number, (iv) a communication address, (v) a financial account identifier, (vi) a requested amount of credit, (vii) a requested financial account type, (viii) an application time, (ix) an application date, (x) a date of birth, (xi) an address type, and (xii) an indication of another authorized financial account user.

15. The method of claim 1, further comprising:
receiving an application response from the decision system.

16. The method of claim 15, further comprising:
forwarding the application response to the wireless device.

17. The method of claim 15, wherein the application response comprises at least one of: (i) an indication of acceptance, (ii) an indication of denial, (iii) a financial account number, (iv) terms and conditions associated with the financial account, (v) an effective date, (vi) an approved amount of credit, (vii) a financial account type, (viii) a communication address, and (ix) discount information.

18. The method of claim 15, further comprising:
formatting the application response before the application response is transmitted to the wireless device.

19. The method of claim 1, wherein the financial account comprises at least one of: (i) a credit card account, (ii) a debit card account, and (iii) a banking account.

20. A computer-implemented method of facilitating an acquisition of information associated with a requested credit card account, comprising:
receiving application information from a mobile device via a wireless network at a location, the application information being associated with the requested credit card account;
verifying that the application information is complete at a forwarding server located at the location;
transmitting the application information to a remote decision system via a wired network, wherein the decision system (i) is associated with the requested credit card account and (ii) is not directly associated with the location;
receiving an application response from the decision system via the wired network; and
transmitting the application response to the mobile device via the wireless network.

21. A forwarding server, comprising:
a processor; and
a storage device in communication with said processor and storing instructions adapted to be executed by said processor to:
receive application information from a wireless device located at a merchant's premises, the application information being associated with a requested financial account, and
arrange for the application information to be provided to a remote decision system associated with the requested financial account.

22. The forwarding server of claim 21, wherein said storage device further stores at least one of: (i) an application information database, (ii) an application response database.

23. The forwarding server of claim 21, further comprising:
a communication device coupled to said processor and adapted to communicate with at least one of: (i) a wireless device, (ii) a forwarding server, and (iii) a decision system.

24. A medium storing instructions adapted to be executed by a processor to perform a method of facilitating an acquisition of information associated with a requested financial account, said method comprising:
receiving application information from a wireless device located at a merchant's premises, the application information being associated with the requested financial account; and
arranging for the application information to be provided to a remote decision system associated with the requested financial account.

25. A method of facilitating an acquisition of information associated with a requested financial account, comprising:
receiving application information from a customer;
transmitting the application information to a forwarding server via a wireless network, the forwarding server being in communication with a decision system; and
receiving an application response from the forwarding server via the wireless network, the application response being generated by the decision system.

26. The method of claim 25, wherein said receiving is performed via at least one of: (i) a card reading device, and (ii) an electronic signature capturing device.

27. The method of claim 25, further comprising providing information to the customer via at least one of: (i) a printing device, and (ii) a card generating device.

28. A wireless device, comprising:
a processor; and
a storage device in communication with said processor and storing instructions adapted to be executed by said processor to:
receive application information from a customer,
transmit the application information to a forwarding server via a wireless network, the forwarding server being in communication with a decision system, and
receive an application response from the forwarding server via the wireless network, the application response being generated by the decision system.

29. The wireless device of claim 28, further comprising a card reading device coupled to said processor.

30. The wireless device of claim 28, further comprising an electronic signature capturing device coupled to said processor.

31. The wireless device of claim 28, further comprising a printing device coupled to said processor.

32. The wireless device of claim 28, further comprising a card generating device coupled to said processor.
